(19) United States
(12) Patent Application Publication
(10) Pub. No.: US 2023/0120484 A1
(43) Pub. Date: Apr. 20, 2023

(54) CARBON DIOXIDE UTILIZATION SYSTEM

(71) Applicant: GT Co., Ltd., Ulsan (KR)

(72) Inventors: Gun Tae KIM, Ulsan (KR); Jeong Won KIM, Ulsan (KR); Chang Min KIM, Ulsan (KR); A Rim SEONG, Ulsan (KR)

(73) Assignee: GT Co., Ltd., Ulsan (KR)

(21) Appl. No.: 17/502,711

(22) Filed: Oct. 15, 2021

(51) Int. Cl. C25B 1/02; C25B 9/00

(52) U.S. Cl. CPC C25B 1/02; C25B 9/00

(57) ABSTRACT

Disclosed are a carbon dioxide utilization system capable of producing electricity, hydrogen, and bicarbonate by utilizing carbon dioxide, which is a greenhouse gas, through a spontaneous electrochemical reaction without a separate external power source, and producing magnesium hydrogen carbonate by reacting the hydrogen carbonate ions with magnesium ions generated at an anode.

### BACKGROUND

The present disclosure relates to a carbon dioxide utilization system capable of producing electricity, hydrogen, and magnesium hydrogen carbonate by utilizing carbon dioxide through a spontaneous electrochemical reaction without an external power source.

Recently, the emission of greenhouse gases is continuously increasing with industrialization, and carbon dioxide accounts for the largest proportion of greenhouse gases. According to the type of industry, the emission of carbon dioxide is the highest in energy supply sources such as power plants and the like, and carbon dioxide generated in the cement/steel/refining industries, including power generation, accounts for half of the world's carbon dioxide generation. The conversion/utilization fields of carbon dioxide are roughly classified into chemical conversion, biological conversion, and direct utilization, and the technical categories can be classified into catalysts, electrochemical processes, bioprocesses, light utilization, mineralization (carbonation), polymers, etc. Since carbon dioxide is generated in various industries and processes, and it is not possible to achieve carbon dioxide reduction with one technology, various approaches for reducing carbon dioxide are required.

Currently, the Department of Energy (DOE) of the United States is pursuing the development of diversified technology with interest in CCUS technology that is a combination of carbon capture & storage (CCS) and carbon capture & utilization (CCU) as a technology of reducing carbon dioxide. Although the CCUS technology is recognized as an effective greenhouse gas reduction method, it faces the problems of high investment costs, the possibility of emission of harmful capturing agents to the atmosphere, and low technology readiness level. In addition, in view of energy and climate policies, the CCUS technology provides a means for substantially reducing the emission of greenhouse gases, but there are many supplementary points for realizing the technology. Therefore, there is a need to develop a new concept of breakthrough technology for more efficiently capturing, storing, and utilizing carbon dioxide.

As a prior patent document related to the technical field of the present disclosure, Korean Laid-Open Patent Publication No. 10-2015-0091834 discloses a sodium secondary battery that captures carbon dioxide.

### RELATED ART DOCUMENT

### Patent Document

Korean Patent Laid-Open Publication No. 10-2015-0091834 “Secondary Battery for capturing CO₂” (published on Aug. 12, 2015)

### SUMMARY

An object of the present disclosure is to provide a system that utilizes carbon dioxide, which is a greenhouse gas, through a spontaneous electrochemical reaction without using a separate power source.

Another object of the present disclosure is to provide a carbon dioxide utilization system capable of producing high purity hydrogen, which is an environmentally friendly fuel, by utilizing carbon dioxide. Still another object of the present disclosure is to provide a carbon dioxide utilization system capable of capturing carbon dioxide as hydrogen carbonate ions (HCO₃⁻) and producing magnesium hydrogen carbonate (Mg(HCO₃)₂) using the hydrogen carbonate ions.

Yet another object of the present disclosure is to provide a carbon dioxide utilization system capable of capturing carbon dioxide as carbonate ions (CO₃²⁻) and producing magnesium carbonate (MgCO₃) using the carbonate ions.

One aspect of the present disclosure provides a carbon dioxide utilization system which includes: a reaction space which accommodates an aqueous solution; a cathode at least partially submerged in the aqueous solution in the reaction space; and a magnesium anode at least partially submerged in the aqueous solution in the reaction space, wherein carbon dioxide introduced into the aqueous solution is captured as hydrogen carbonate ions (HCO₃⁻) to produce hydrogen ions, and the hydrogen ions react with electrons of the cathode to produce hydrogen.

Another aspect of the present disclosure provides a carbon dioxide utilization system which includes: a reaction space which accommodates an aqueous solution; a cathode at least partially submerged in the aqueous solution in the reaction space; and a magnesium anode at least partially submerged in the aqueous solution in the reaction space, wherein carbon dioxide introduced into the aqueous solution is captured as carbonate ions (CO₃²⁻) to produce hydrogen ions, and the hydrogen ions react with electrons of the cathode to produce hydrogen.

### BRIEF DESCRIPTION OF THE DRAWINGS

FIG. 1 is a schematic diagram illustrating an operation process of a carbon dioxide utilization system according to an embodiment of the present disclosure.

FIG. 2 is a schematic diagram illustrating the operation process of a carbon dioxide utilization system including a carbon dioxide treatment unit according to an embodiment of the present disclosure.

### DETAILED DESCRIPTION

Hereinafter, the configuration and operation of the embodiment of the present disclosure will be described in detail with reference to the drawings.

The carbon dioxide utilization system 100 of the present disclosure uses carbon dioxide gas (CO₂), which is a greenhouse gas, as a raw material in a spontaneous oxidation and reduction reaction and produces hydrogen (H₂) which is an environmentally friendly fuel.

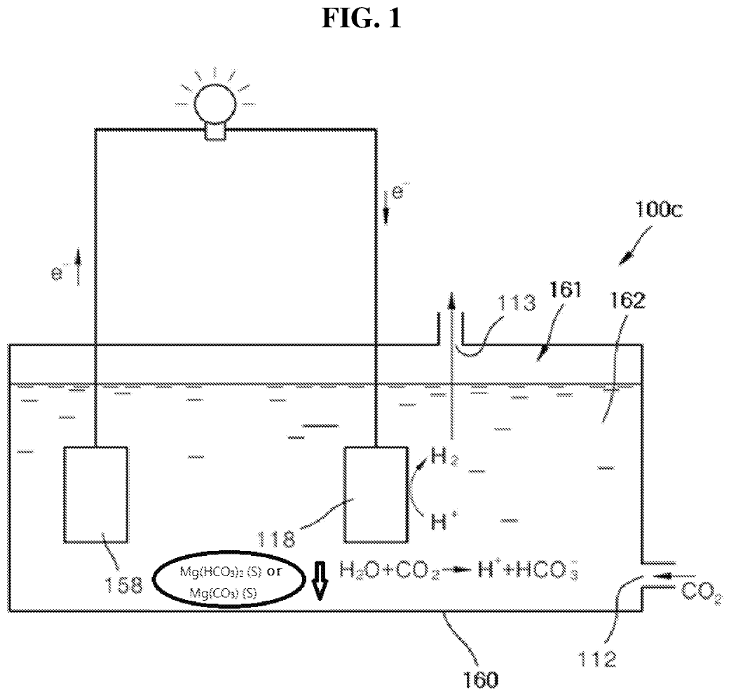

FIG. 1 illustrates the configuration of a carbon dioxide utilization system 100 according to still another embodiment of the present disclosure. Referring to FIG. 1, the carbon dioxide utilization system 100 according to an embodiment of the present disclosure includes a reaction space 161 which accommodates an aqueous solution 162, a cathode 118 at least partially submerged in the aqueous solution 162 in the reaction space 161, and a magnesium anode 158 at least partially submerged in the aqueous solution 162 in the reaction space 161.

A reaction vessel 160 provides the reaction space 161 which contains the aqueous solution 162 and accommodates the cathode 118 and the anode 158. In the reaction vessel 160, a first inlet 112 and a first outlet 113, both of which communicate with the reaction space 161, are formed. The first inlet 112 is positioned at a lower part of the reaction space 161 so that it is positioned below a water surface of the aqueous solution 162. The first outlet 113 is positioned at an upper part of the reaction space 161 so that it is positioned above a water surface of the aqueous solution 162. The carbon dioxide gas used as a fuel in a reaction process is introduced into the reaction space 161 through the first inlet 112, and, if necessary, the aqueous solution 162 may also be introduced. The gas produced in a reaction process is discharged to the outside through the first outlet 113. The first inlet 112 and the first outlet 113 may be selectively opened and closed by a valve (not illustrated), etc., during a reaction in a timely manner. In the reaction space 161, an elution reaction of carbon dioxide occurs during a reaction process.

The aqueous solution 162 is contained in the reaction space 161, and at least a part of the cathode 118 and at least a part of the anode 158 are submerged in the aqueous solution 162. Since the carbon dioxide utilization system of the present disclosure uses magnesium metal (Mg) as an anode, an oxidation reaction may occur well even in a neutral solution. Thus, various types of aqueous solutions 162 may be used regardless of pH as well as a basic solution, seawater, etc.

It is described in the present embodiment that a basic solution or seawater is used as the aqueous solution 162. The aqueous solution 162 becomes weakly acidic due to the carbon dioxide gas introduced through the first inlet 112 in a reaction process.

The cathode 118 is at least partially submerged in the aqueous solution 162 in the reaction space 161. The cathode 118 is positioned relatively closer to the first inlet 112 than the anode 158 in the reaction space 161. The cathode 118 is an electrode for forming an electrical circuit, and may be carbon paper, a carbon fiber, carbon felt, carbon cloth, metal foam, a metal thin film, or combinations thereof, and a platinum catalyst may also be used. In the case of a catalyst, in addition to a platinum catalyst, all other catalysts generally usable as a catalyst for a hydrogen evolution reaction (HER), such as carbon-based catalysts, carbon-metal-based complex catalysts, and perovskite oxide catalysts, etc., may also be used. During a reaction, a reduction reaction occurs in the cathode 118, and accordingly, hydrogen is generated.

The anode 158 is at least partially submerged in the aqueous solution 162 in the reaction space 161. The anode 158 is positioned relatively farther from the first inlet 112 than the cathode 118 in the reaction space 161. The anode 158 is a metal electrode for forming an electrical circuit, and it is described in the present disclosure that the anode 158 is made of magnesium (Mg). During a reaction, an oxidation reaction occurs in the anode 158 due to a weakly acidic environment.

Hereinafter, the reaction process of a carbon dioxide utilization system 100c described above with respect to the configuration will be described in detail. FIG. 1 also illustrates the reaction process of the carbon dioxide utilization system 100c. Referring to FIG. 1, carbon dioxide gas is injected into the aqueous solution 162 through the first inlet 112, and a chemical elution reaction of carbon dioxide as shown in the following Reaction Scheme 1 occurs in the reaction space 161.

H₂O(l)+CO₂(g)→H⁺(aq)+HCO₃⁻(aq) [Reaction Scheme 1]

That is, the carbon dioxide (CO₂) supplied to the reaction space 161 is subjected to a spontaneous electrochemical reaction with water (H₂O) of the aqueous solution 162 to produce a hydrogen cation (H⁺) and hydrogen carbonates ions (HCO₃⁻).

In addition, an electrical reaction as shown in the following Reaction Scheme 2 occurs in the cathode 118.

2H⁺(aq)+2e⁻→H₂(g) [Reaction Scheme 2]

That is, the hydrogen cation (H³⁰ ) receives an electron (e⁻) around the cathode 118 to generate hydrogen (H₂) gas. The generated hydrogen (H₂) gas is discharged to the outside through the first outlet 113.

In addition, a complex hydrogen evolution reaction as shown in the following Reaction Scheme 3 occurs around the cathode 118.

2H₂O(l)+2CO₂(g)+2e⁻→H₂(g)+2HCO₃⁻(aq) [Reaction Scheme 3]

In addition, carbonate ions (CO₃²⁺) may be produced in a small amount through a reaction as shown in the following Reaction Scheme 4.

HCO₃⁻(aq)→H⁺+CO₃²⁻(aq) [Reaction Scheme 4]

In addition, in the anode 158 made of magnesium (Mg), an oxidation reaction as shown in the following Reaction Scheme 5 occurs.

Mg→Mg²⁺+2e⁻(E⁰=−2.372 V) [Reaction Scheme 5]

The reaction scheme of the overall reaction occurring in a reaction process is the same as the following Reaction Scheme 6 or Reaction Scheme 7.

Mg+2CO₂+2H₂O→Mg(HCO₃)₂(s)+H₂(g) E^{o}=2.372 V [Reaction Scheme 6]

Mg+CO₂+H₂O→MgCO₃(s)+H₂(g) E^{o}=2.372 V [Reaction Scheme 7]

As a result, as can be seen from Reaction Scheme 6 and Reaction Scheme 7, the hydrogen ions produced by carbon dioxide eluted from the aqueous solution 162 during the reaction receive electrons from the cathode 118, and are thus reduced to hydrogen gas, so that the hydrogen gas is discharged through the first outlet 113, and the magnesium anode 158 is changed into an oxide form. As the reaction proceeds, hydrogen carbonate ions (HCO₃⁻) or a small amount of carbonate ions (CO₃²⁻) are generated in the aqueous solution 162, and the hydrogen carbonate ions and carbonate ions react with magnesium ions generated at the anode according to Reaction Scheme 6 or Reaction Scheme 7 to produce magnesium hydrogen carbonate (Mg(HCO₃)₂) and magnesium carbonate (MgCO₃).

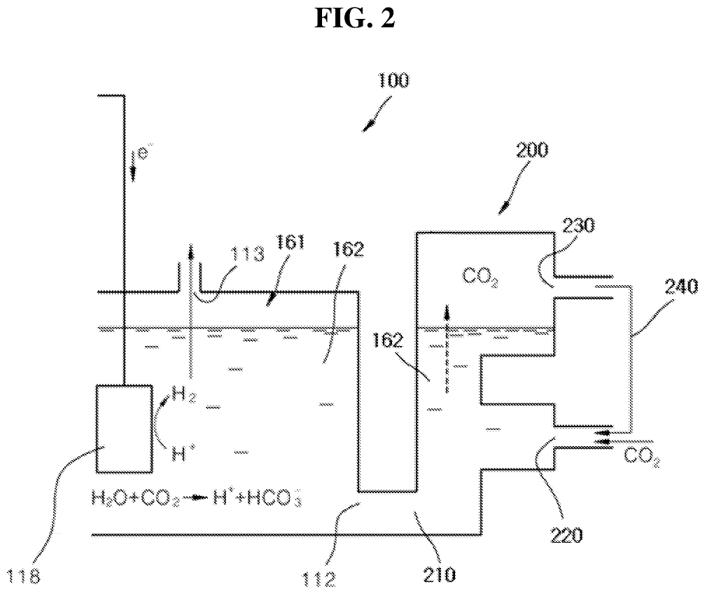

FIG. 2 is a schematic diagram illustrating the reaction process of a carbon dioxide utilization system including a carbon dioxide treatment unit 200 according to an embodiment of the present disclosure. Referring to FIG. 2, the carbon dioxide utilization system 100 may further include a carbon dioxide treatment unit 200. The carbon dioxide treatment unit 200 includes the same aqueous solution as the aqueous solution 162 of the reaction space 161. The carbon dioxide treatment unit 200 may include: a connection pipe 210 which allows the reaction space 161 and the carbon dioxide treatment unit 200 to communicate with each other; a second inlet 220 through which carbon dioxide is introduced; a second outlet 230 positioned at an upper part thereof, and a carbon dioxide circulation supply unit 240. Since the carbon dioxide utilization system 100 is the same as that described in the embodiment illustrated in FIG. 1, the detailed description thereof will be omitted.

The second inlet 220 is positioned above the connection pipe 210 and below the outlet 230 and the water surface of the aqueous solution 162 in the carbon dioxide treatment unit 200. Through the second inlet 220, carbon dioxide gas to be used as a fuel in a reaction process is introduced into the carbon dioxide treatment unit 200. Through the second inlet 220, the first aqueous solution 115 or the aqueous solution 162 may also be supplied as necessary. The second inlet 220 and the first outlet 113 may be selectively opened and closed by a valve, etc., during a reaction in a timely manner.

The connection pipe 210 is positioned below the second inlet 220 in the carbon dioxide treatment unit 200, and the carbon dioxide treatment unit 200 communicates with the reaction space 161 by the connection pipe 210.

The second outlet 230 is positioned above the second inlet 220 and the water surface of the aqueous solution 162 in the carbon dioxide treatment unit 200. Through the second outlet 230, non-ionized carbon dioxide gas, which has not been dissolved in the aqueous solution 162, is discharged from the carbon dioxide treatment unit 200 to the outside. The carbon dioxide gas discharged through the second outlet 230 is supplied to the second inlet 220 through the carbon dioxide circulation supply unit 240.

The carbon dioxide circulation supply unit 240 is configured to circulate and resupply the carbon dioxide gas discharged through the second outlet 230 to the second inlet 220.

The connection pipe 210 is connected to the first inlet 112 of the reaction space 161. Through the connection pipe 210, the reaction space 161 and the carbon dioxide treatment unit 200 communicate with each other.

Non-ionized carbon dioxide gas, which has not been dissolved in the aqueous solution 162, of the carbon dioxide introduced into the carbon dioxide treatment unit 200 through the second inlet 220 does not move to the reaction space 161, rises, and is collected in a space provided above the water surface of the aqueous solution 162 in the carbon dioxide treatment unit 200. Then, the collected carbon dioxide gas is discharged through the second outlet 230.

The carbon dioxide gas discharged through the second outlet 230 is supplied to the carbon dioxide treatment unit 200 through the second inlet 220 and recycled by the carbon dioxide circulation supply unit 240. In addition, since non-ionized carbon dioxide gas, which has not been dissolved in the aqueous solution 162, of the carbon dioxide introduced into the carbon dioxide treatment unit 200 does not move to the reaction space 161, high purity hydrogen, which is not mixed with carbon dioxide, may be discharged through the first outlet 113.

According to the present disclosure, all of the objects of the present disclosure described above may be achieved. Specifically, electricity, hydrogen, hydrogen carbonate ions, and carbonate ions may be produced by utilizing carbon dioxide through a spontaneous electrochemical reaction without using a separate external power source, and the hydrogen carbonate ions or carbonate ions may react with magnesium ions generated at an anode to produce magnesium hydrogen carbonate (Mg(HCO₃)₂) or magnesium carbonate (MgCO₃).

While the present disclosure has been described above with reference to the exemplary embodiments, the present disclosure is not limited thereto. The above embodiments may be modified or changed without departing from the scope and spirit of the present disclosure, and it will be understood by those skilled in the art that these modifications and changes are also included in the scope of the present disclosure.

What is claimed is:

1. A carbon dioxide utilization system, comprising:
a reaction space which accommodates an aqueous solution;
a cathode at least partially submerged in the aqueous solution in the reaction space; and
a magnesium anode at least partially submerged in the aqueous solution in the reaction space,
wherein carbon dioxide introduced into the aqueous solution is captured as hydrogen carbonate ions (HCO₃⁻), or hydrogen carbonate ions (HCO₃⁻) and carbonate ions (CO₃²⁻) to produce hydrogen ions, and the hydrogen ions react with electrons of the cathode to produce hydrogen.

2. The carbon dioxide utilization system of claim 1, wherein the hydrogen carbonate ions react with magnesium ions (Mg²⁺) generated at the anode to produce magnesium hydrogen carbonate (Mg(HCO₃)₂).

3. The carbon dioxide utilization system of claim 1, wherein the carbonate ions react with magnesium ions (Mg²⁺) generated at the anode to produce magnesium carbonate (MgCO₃).

4. The carbon dioxide utilization system of claim 1, wherein the reaction space includes a first outlet configured to discharge the produced hydrogen, and the first outlet is positioned above a water surface of the aqueous solution.

5. The carbon dioxide utilization system of claim 1, further comprising a carbon dioxide treatment unit including a first connection pipe which allows the reaction space and the aqueous solution to communicate with each other,
wherein the carbon dioxide treatment unit does not allow non-ionized carbon dioxide of the introduced carbon dioxide to be supplied to the reaction space.

6. The carbon dioxide utilization system of claim 5, wherein the carbon dioxide treatment unit allows the non-ionized carbon dioxide to be separated using a difference in specific gravity with the aqueous solution in the carbon dioxide treatment unit.

7. The carbon dioxide utilization system of claim 5, wherein the carbon dioxide treatment unit allows the non-ionized carbon dioxide to be collected above a water surface of the aqueous solution in the carbon dioxide treatment unit.

8. The carbon dioxide utilization system of claim 5, wherein the carbon dioxide treatment unit includes an inlet positioned below a water surface of the aqueous solution in the carbon dioxide treatment unit and configured to introduce carbon dioxide, and
the first connection pipe is positioned below the inlet.

9. The carbon dioxide utilization system of claim 5, wherein the carbon dioxide treatment unit includes a second outlet positioned above a water surface of the aqueous solution in the carbon dioxide treatment unit and configured to discharge the non-ionized carbon dioxide.

10. The carbon dioxide utilization system of claim 5, wherein the carbon dioxide treatment unit further includes a carbon dioxide circulation supply unit configured to supply the non-ionized carbon dioxide separated from the aqueous solution of the reaction space to the aqueous solution in the carbon dioxide treatment unit.
